(19) United States
(12) Patent Application Publication
(10) Pub. No.: US 2021/0044864 A1
(43) Pub. Date: Feb. 11, 2021

(54) METHOD AND APPARATUS FOR IDENTIFYING VIDEO CONTENT BASED ON BIOMETRIC FEATURES OF CHARACTERS

(71) Applicant: SAMSUNG ELECTRONICS CO., LTD., Suwon-si (KR)

(72) Inventors: Andriy BEGUN, Kyiv (UA); Vitalij TYMCHYSHYN, Kyiv (UA); Andrey BUGAYOV, Kyiv (UA)

(73) Assignee: SAMSUNG ELECTRONICS CO., LTD., Suwon-si (KR)

(21) Appl. No.: 16/985,846

(22) Filed: Aug. 5, 2020

(30) Foreign Application Priority Data
Aug. 5, 2019 (KR) 10-2019-0095178

(51) Int. Cl. H04N 21/44; G06K 9/00; H04N 21/81

(52) U.S. Cl. CPC H04N 21/44008; H04N 21/8133; G06K 9/00248; G06K 9/00744

(57) ABSTRACT

An apparatus for identifying video content including a memory storing one or more instructions; and at least one processor configured to execute the one or more instructions to: receive video content; detect biometric features of characters in the video content; identify the characters based on the detected biometric features; identify the video content based on the identity of the characters; and output a content identifier of the video content based on the identity of the video content.

### CROSS-REFERENCE TO RELATED APPLICATION

This application is based on and claims priority under 35 U.S.C. §119 to Korean Patent Application No. 10-2019-0095178, filed on Aug. 5, 2019, in the Korean Intellectual Property Office, the disclosure of which is incorporated by reference herein in its entirety.

### BACKGROUND

### 1. Field

The disclosure relates to a method and apparatus for identifying video content based on biometric features of characters.

### 2. Description of Related Art

Along with the development of computer and Internet technologies, many pieces of video content such as movies and TV series are distributed, and thus, there is demand for a technique of identifying video content. The technique of identifying video content may be used for statistical analysis of consumption of video content, detection of consumers' tendencies, recommendation of video content or other products, and the like.

Artificial intelligence (AI) systems get smarter while a machine self-learns and self-determines, unlike conventional rule-based smart systems. The more an AI system is used, the more the AI system's recognition rate improves and the more it can accurately understand user preferences, and thus, existing rule-based smart systems are gradually being replaced with deep learning-based AI systems. AI technology includes machine learning (deep learning) and element technologies using the machine learning. Machine learning is an algorithm-based technology that self-classifies/self-learns features of input data. Element technologies are technologies utilizing a machine learning algorithm, such as deep learning, which include technical fields such as linguistic understanding, visual understanding, inference/prediction, knowledge representation, and motion control.

### SUMMARY

According to an aspect of the disclosure, an apparatus for identifying video content includes a memory storing one or more instructions; and at least one processor configured to execute the one or more instructions to: receive video content; detect biometric features of characters in the video content; identify the characters based on the detected biometric features; identify the video content based on the identity of the characters; and output a content identifier of the video content based on the identity of the video content.

The at least one processor may be configured to execute the one or more instructions to: extract a first frame from the video content; detect biometric features included in the first frame; identify the video content based on the biometric features included in the first frame; and when the video content is not identifiable based on the biometric features included in the first frame, extract a second frame from the video content, detect biometric features included in the second frame, and identify the video content based on the detected biometric features included in the second frame.

The at least one processor may be configured to execute the one or more instructions to: identify the characters based on the detected biometric features being matched with a person-specific biometric feature stores in a person-specific biometric feature database; and identify the video content based on the identified characters being matched with a character list stored in a content-specific character database.

The at least one processor may be configured to execute the one or more instructions to store a biometric feature detected in the video content, by which a character has not been identified, in a content-specific non-identified biometric feature database by matching the biometric feature with the content identifier of the video content.

The at least one processor may be configured to execute the one or more instructions to: generate a temporary content identifier of the video content; and store a biometric feature detected in the video content, by which a character has not been identified, in a content-specific non-identified biometric feature database by matching the biometric feature with the temporary content identifier of the video content.

The at least one processor may be further configured to execute the one or more instructions to store biometric features detected in the video content, by which no characters have been identified, in a content-specific non-identified biometric feature database by matching different types of biometric features corresponding to a same person with each other.

The at least one processor may be configured to execute the one or more instructions to: classify biometric features detected in the video content, by which no characters have been identified, on a per person basis through machine learning; and store the classified person-based biometric features in a content-specific non-identified biometric feature database by matching the classified person-based biometric features with a temporary person identifier of a person having a matching biometric feature.

The at least one processor may be configured to execute the one or more instructions to: classify the biometric features on a per person basis based on different types of biometric features corresponding to a same person; and apply weights corresponding to the types of the biometric features.

The at least one processor may be configured to execute the one or more instructions to identify a character corresponding to a biometric feature that has not been identified through a person-specific biometric feature database, based on a matching biometric feature in a content-specific non-identified biometric feature database.

The at least one processor may be configured to execute the one or more instructions to identify a character corresponding to a non-identified biometric feature of the received video content based on comparing a non-identified character list and non-identified biometric features of the received video content with a non-identified character list and non-identified biometric features of a video content in a content-specific non-identified biometric feature database.

The at least one processor may be configured to execute the one or more instructions to identify a character corresponding to a non-identified biometric feature of the received video content based on comparing a content-specific character database with a non-identified character list and non-identified biometric features of each identified video content among the received video content and video contents in a content-specific non-identified biometric feature database and an identified character list and non-identified biometric features of each non-identified video content among the received video content and video contents in the content-specific non-identified biometric feature database.

The at least one processor may be configured to execute the one or more instructions to identify the received video content based on comparing a content-specific character database with a non-identified character list and non-identified biometric features of each identified video content among the received video content and video contents in a content-specific non-identified biometric feature database and an identified character list and non-identified biometric features of each non-identified video content among the received video content and video contents in the content-specific non-identified biometric feature database.

The at least one processor may be configured to execute the one or more instructions to: identify the characters based on the detected biometric features being matched with biometric features stored in a content-specific non-identified biometric feature database; and store the detected biometric features in a person-specific biometric feature database by matching the detected biometric features with person identifiers of the characters.

The at least one processor may be configured to execute the one or more instructions to: detect a first type of biometric feature of a character in the video content; identify the character based on the detected first type of biometric feature being matched with a biometric feature stored in a content-specific non-identified biometric feature database; and store a second type of biometric feature, that is matched with the detected first type of biometric feature and stored in the content-specific non-identified biometric feature database, in a person-specific biometric feature database by matching the second type of biometric feature with a person identifier of the character.

The at least one processor may be further configured to execute the one or more instructions to: detect a first type of biometric feature and a second type of biometric feature of a character in the video content; identify the character based on the detected first type of biometric feature being matched with a biometric feature stored in a person-specific biometric feature database; and store the detected second type of biometric feature in the person-specific biometric feature database by matching the detected second type of biometric feature with a person identifier of the character.

The at least one processor may be configured to execute the one or more instructions to: detect a first type of biometric feature and a second type of biometric feature of a character in the video content; identify the character based on the detected first type of biometric feature being matched with a biometric feature stored in a person-specific biometric feature database; and store a third type of biometric feature, that is matched with the detected second type of biometric feature and stored in a content-specific non-identified biometric feature database, in the person-specific biometric feature database by matching the third type of biometric feature with a person identifier of the character.

The at least one processor may be further configured to execute the one or more instructions to update the content-specific character database based on at least one of the detected biometric features, the person-specific biometric feature database, or the content identifier of the video content.

According to another aspect of the disclosure, an apparatus includes a memory storing one or more instructions; and at least one processor configured to execute the one or more instructions to: receive video content; detect biometric features of characters in the video content; identify the characters based on the detected biometric features; and update the biometric feature database based on the detected biometric features and a result of identifying the characters.

According to another aspect of the disclosure, a method of identifying video content may include receiving video content; detecting biometric features of characters in the video content; identifying the characters based on the detected biometric features; identifying the video content based on a result of identifying the characters; and outputting a content identifier of the video content based on a result of identifying the video content.

A non-transitory computer-readable recording medium may have recorded thereon a program for executing a method of identifying video content.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing a method of identifying video content based on biometric features of characters, according to an example embodiment;

FIG. 2 is a flowchart of a method, performed by an apparatus for identifying video content, of identifying video content based on biometric features of characters, according to an example embodiment;

FIG. 3 is a block diagram of an apparatus for identifying video content based on biometric features of characters, according to an example embodiment;

FIG. 4 is a block diagram of a database device which a processor accesses from an apparatus for identifying video content based on biometric features of characters, according to an example embodiment;

FIG. 5 is a flowchart of a method of identifying video content based on biometric features of characters, according to an example embodiment;

FIG. 6 is a flowchart of a method of identifying video content based on biometric features of characters, according to an example embodiment;

FIG. 7 is a flowchart of a non-identified biometric feature processing operation according to an example embodiment;

FIG. 8 shows a diagram showing how one human shape is recognized from an image of video content, according to an example embodiment;

FIG. 9 shows a process of classifying biometric features of video content on a person basis, according to an example embodiment;

FIG. 10 shows an example of data stored in a content-specific non-identified biometric feature database, according to an example embodiment;

FIG. 11 is a flowchart of a non-identified biometric feature processing operation according to an example embodiment;

FIG. 12 shows a non-identified character identification operation according to a first example embodiment;

FIG. 13 shows a non-identified character identification operation according to a second example embodiment;

FIG. 14 shows an operation of updating a person-specific biometric feature database, according to an example embodiment;

FIG. 15 shows an operation of updating a person-specific biometric feature database, according to an example embodiment;

FIG. 16 shows an operation of updating a person-specific biometric feature database, according to an example embodiment;

FIG. 17 shows a process of adding, to a person-specific biometric feature database, hand shape and ear shape data of an actor whose face has been identified, according to an example embodiment;

FIG. 18 shows an operation of updating a person-specific biometric feature database, according to an example embodiment;

FIG. 19 shows an operation of updating a person-specific biometric feature database, according to an example embodiment;

FIG. 20 is a block diagram of an apparatus for updating a biometric feature database, according to an example embodiment;

FIG. 21 is a flowchart of a video content identification method using biometric features of characters, according to an example embodiment;

FIG. 22 is a flowchart of a method of identifying a non-identified character and updating a database, according to an example embodiment;

FIG. 23 is a flowchart of a method of identifying a non-identified character and updating a database, according to an example embodiment; and

FIG. 24 is a flow of a method of identifying video content based on biometric features of characters, according to an example embodiment.

### DETAILED DESCRIPTION

Example embodiments of the disclosure will be described in detail with reference to the accompanying drawings so that those of ordinary skill in the art to which the disclosure belongs may easily realize the disclosure. However, the disclosure may be embodied in many different forms and should not be construed as being limited to the example embodiments set forth herein. Specific executions described in the disclosure are illustrative and do not limit the scope of the disclosure. For conciseness of the specification, disclosure of conventional electronic configurations, control systems, software, and other functional aspects of the systems may be omitted.

In the drawings, parts irrelevant to the description are omitted to clearly describe the disclosure, and like reference numerals denote like elements throughout the specification. The relative size and depiction of these elements are not necessarily to scale and may be exaggerated for clarity, illustration, and convenience. Connection or connection members of lines between components shown in the drawings indicate functional connections and/or physical or circuit connections. The connections between components may be represented by replaceable or additional various functional connections, physical connections, or circuit connections in an actual apparatus.

The terms used in the disclosure are general terms currently widely used in the art, but the terms may vary according to the intention of those of ordinary skill in the art, precedents, or new technology in the art. Thus, the terms used in the present disclosure should not be defined by simple names but based on the meaning of the terms and the overall description of the disclosure. Although terms, such as ‘first’ and ‘second’, can be used to describe various elements, the elements cannot be limited by the terms. The terms can be used to classify a certain element from another element. The expressions such as “in an example embodiment” stated in various parts of the disclosure do not necessarily indicate the same embodiment.

The expression “at least one of a, b and c” indicates only a, only b, only c, both a and b, both a and c, both b and c, all of a, b, and c, or variations thereof.

An example embodiment may be represented with functional blocks and various processing steps. Some of these functional blocks may be implemented by various numbers of hardware and/or software configurations for executing specific functions. For example, functional blocks of the disclosure may be implemented by one or more microprocessors or by circuit configurations for a certain function. In addition, for example, functional blocks of the disclosure may be implemented by a programming or scripting language. Functional blocks may be implemented with algorithms executed in one or more processors. In addition, the disclosure may adopt the prior art for electronic environment setup, signal processing, and/or data processing.

When it is determined that a specific description of relevant well-known features or components may obscure the essentials of the disclosure, a detailed description thereof is omitted. In accordance with circumstances, both an apparatus and a method may be described for convenience of description.

Hereinafter, the disclosure will be described in detail with reference to the accompanying drawings.

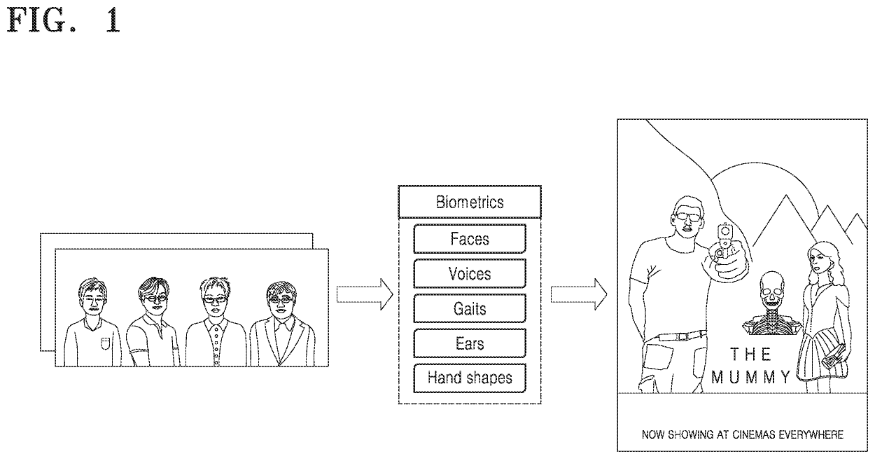

FIG. 1 shows a method of identifying video content based on biometric features of characters, according to an example embodiment. Referring to FIG. 1, the method may include an operation of detecting biometric features from video content and identifying the video content based on the detected biometric features. The biometric features may include features of human physical shapes, such as a face, a fingerprint, an iris, a retina, an ear, a hand, the lines of the palm, and a vein, and human behavioral features such as a voice, a gait, and a signature. The biometric features may be targets of biometrics. As such, the biometric features commonly indicate human biometric features, but according to embodiments of the disclosure, biometric features of animals may be used.

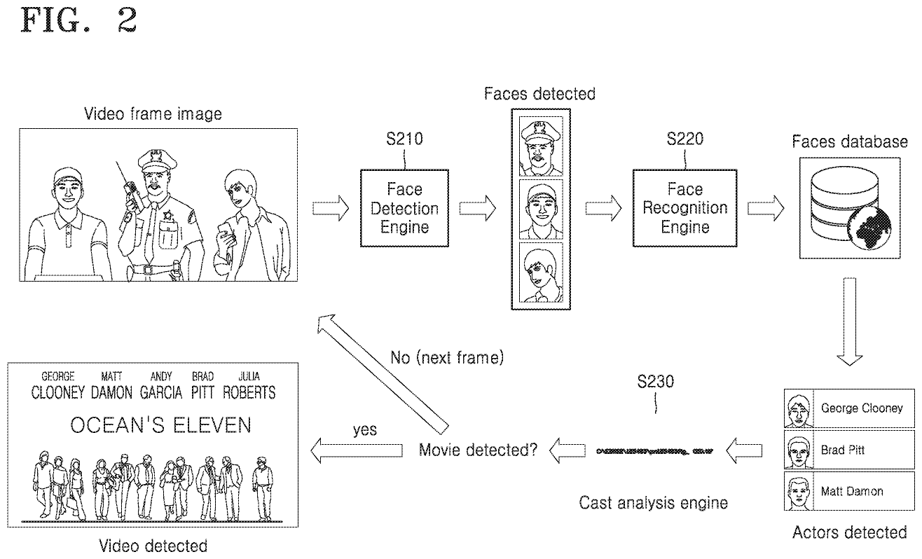

FIG. 2 is a flowchart of a method, performed by an apparatus for identifying video content, of identifying video content based on biometric features of characters, according to an example embodiment. Referring to FIG. 2, the apparatus may detect faces of actors/actresses from a frame of video content based on face recognition in operation S210 and then identify names of the actors/actresses based on a face database in operation S220. The apparatus may identify a name of the video content based on the names of the actors/actresses in operation S230. When the name of the video content cannot be identified based on only the identified names of the actors/actresses, the same process as described above may be performed on another frame of the video content. This process may be repeated until the name of the video content is identified. As such, when video content is identified by detecting biometric features of characters in the video content, the video content may be directly identified based on the video content without separate additional information, and thus, video content may be simply identified without a watermark being previously inserted into the video content, a fingerprint previously generated in the video content, or the like.

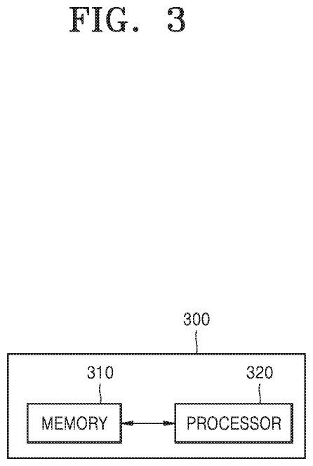

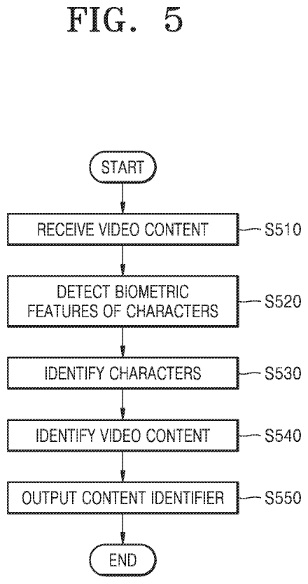

FIG. 3 is a block diagram of an apparatus 300 for identifying video content based on biometric features of characters, according to an example embodiment. Referring to FIG. 3, the apparatus 300 may include a memory 310 storing one or more instructions and a processor 320 configured to execute the one or more instructions stored in the memory 310. The memory 310 may include a single memory or a plurality of memories. The processor 320 may include a single processor or a plurality of processors. An operation of the processor 320 will be described below in detail with reference to FIG. 5.

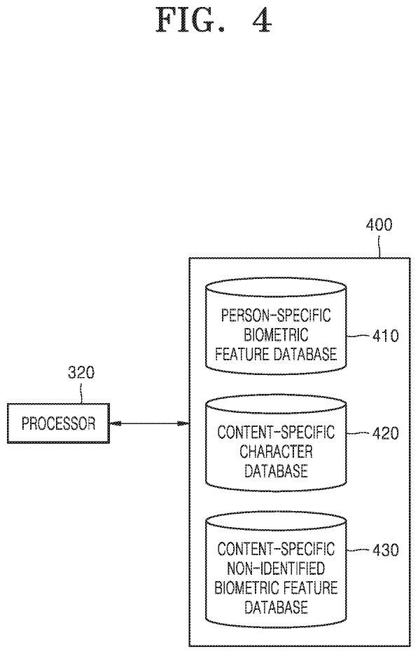

FIG. 4 is a block diagram of a database device 400 which the processor 320 accesses from the apparatus 300, according to an example embodiment. Referring to FIG. 4, the database device 400 which the processor 320 accesses using biometric features of characters may include at least one of a person-specific biometric feature database 410, a content-specific character database 420, and a content-specific non-identified biometric feature database 430. Each database will be described below in detail. The database device 400 may include a set of data implemented using a specialized database management system (DBMS), as well as any type of structured data. The database device 400 may be included in the video content identification apparatus 300 or may be a separate device.

FIG. 5 is a flowchart showing a method of identifying video content based on biometric features of characters, according to an example embodiment. Referring to FIG. 5, in operation S510, the processor 320 may receive video content. Hereinafter, without special limitation, the term ‘video content’ indicates the video content received in operation S510, i.e., video content to be currently analyzed, and may indicate ‘present video content’ when the video content may be configured with other video content. In operation S520, the processor 320 may detect biometric features of characters in the video content. The biometric features may include at least one of face shapes, voices, gaits, hand shapes, or ear shapes. The processor 320 may detect biometric features of characters from one or more frames of video content. For example, the face shapes may be detected from one frame, and the gaits may be detected from a plurality of frames. The processor 320 may detect one or more biometric features from video content and may detect a plurality of biometric features to identify video content.

In operation S530, the processor 320 may identify corresponding characters based on the detected biometric features. The processor 320 may use the person-specific biometric feature database 410 to identify characters from the detected biometric features. That is, the processor 320 may identify characters based on biometric features detected from video content being matched with a biometric feature stored in the person-specific biometric feature database 410.

The person-specific biometric feature database 410 may store biometric features such as face shapes, voices, gaits, hand shapes, and ear shapes of known people. Biometric features stored in a database may include the biometric features, as well as any type of information indicating unique biometric features. Therefore, storing biometric features in a database may include storing not only the biometric features but also information indicating the biometric features in the database. As described below, the person-specific biometric feature database 410 may be persistently updated.

The processor 320 may identify characters based on one or more biometric features. The processor 320 may identify characters based on a plurality of biometric features detected from a same frame or different frames. The processor 320 may identify characters based on one type of biometric features (e.g., face shapes) or various different types of biometric features (e.g., face shapes and hand shapes).

The processor 320 may use machine learning to identify characters based on detected biometric features. The processor 320 may classify detected biometric features on a person basis based on machine learning and then compare the classified person-based biometric features with the person-specific biometric feature database 410 to identify characters. The processor 320 may identify characters by applying machine learning to the biometric features detected from the present video content and the person-specific biometric feature database 410.

The processor 320 may specify person identifiers for identified characters when the characters are successfully identified. A person identifier is identification information uniquely indicating a person and may conform to an arbitrary format such as a number, a character string, or a binary code. A person identifier may include a name of a corresponding person.

In operation S540, the processor 320 may identify the video content based on a result of identifying the characters. The processor 320 may use the content-specific character database 420 to identify video content based on identified characters. That is, the processor 320 may identify video content based on an identification result of characters being matched with a character list stored in the content-specific character database 420.

The content-specific character database 420 may store a character list of known video content. Herein, a character list stored in a database may include person identifiers of characters. A character list of each video content may be matched with a content identifier of corresponding video content and stored. A content identifier is identification information uniquely indicating video content and may conform to an arbitrary format such as a number, a character string, or a binary code. A content identifier may include a title of corresponding video content. A character list of video content may include, for example, a movie cast list and may be constructed based on an existing database such as an internet movies database (IMDB). As described below, the content-specific character database 420 may be persistently updated.

The processor 320 may identify video content based on one or more identified characters and may identify a plurality of characters to identify video content. The processor 320 may identify video content based on person identifiers of identified characters. The processor 320 may identify video content by comparing person identifiers of identified characters with the content-specific character database 420. The processor 320 may use machine learning to identify video content based on identified characters.

The processor 320 may specify a content identifier of identified video content when the video content is successfully identified. In operation S550, the processor 320 may output a content identifier of the video content based on a result of identifying the video content.

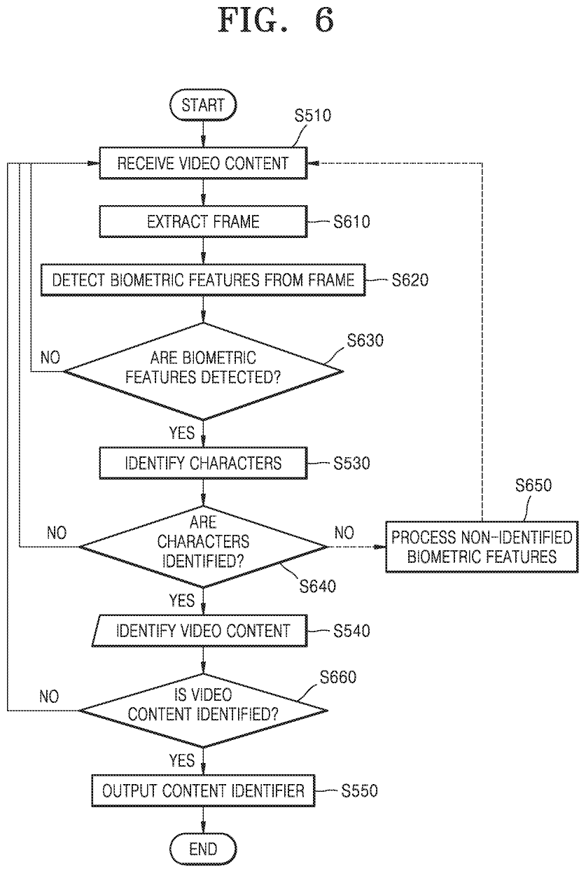

FIG. 6 is a flowchart showing a method of identifying video content based on biometric features of characters, according to an example embodiment. In a description of FIG. 6, the description made in relation to of FIG. 5 may be omitted to prevent redundancy. Referring to FIG. 6, in operation S610, the processor 320 may extract a frame from received video content. The extracted frame may include a single frame or a plurality of frames. For example, when a face or hand shape is detected from video content, one frame may be extracted, and when voices or gaits are detected from video content, a plurality of frames may be extracted. A frame may include not only image data but also acoustic data.

In operation S620, the processor 320 may detect biometric features of characters from the extracted frame. In operation S630, the processor 320 may proceed to a character identification operation S530 when biometric features of characters are detected from the extracted frame, and proceed back to the frame extraction operation S610 to extract another frame when no biometric features of characters are detected. Another frame may be extracted sequentially or though other various ways. For example, another frame may be a next frame, a next key frame, a frame after a certain time, a frame in which a scene is changed, or the like. The processor 320 may perform the biometric feature detection operation S620 on a newly extracted frame, and perform the character identification operation S530 when biometric features are detected.

In operation S640, the processor 320 may proceed to the video content identification operation S540 when characters are identified based on the detected biometric features, and proceed back to the frame extraction operation S610 when no characters are identified. The processor 320 may perform the biometric feature detection operation S620 and the character identification operation S530 on a newly extracted frame.

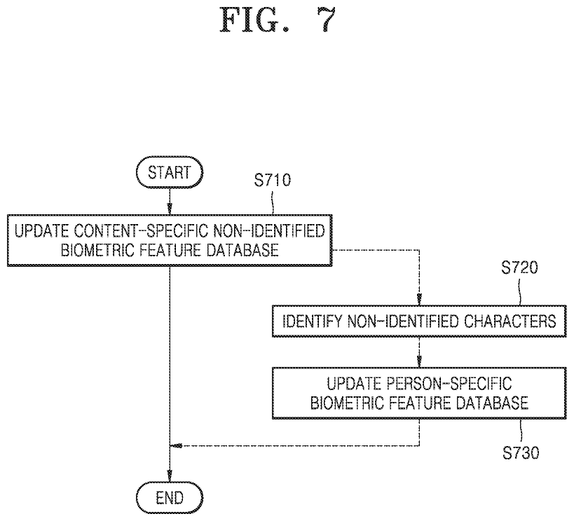

The processor 320 may perform a non-identified biometric feature processing operation S650 when no characters are identified based on the detected biometric features. Hereinafter, a biometric feature by which a character is not identified among biometric features of characters, which have been detected from video content, is referred to as ‘non-identified biometric feature’. A non-identified biometric feature may be a biometric feature by which a character is not identified based on the person-specific biometric feature database 410. The non-identified biometric feature processing operation S650 will be described below in detail with reference to FIGS. 7 to 16.

In operation S660, the processor 320 may proceed to the content identifier output operation S550 when the video content is identified based on a result of identifying the characters, and proceed back to the frame extraction operation S610 when the video content is not identified. The processor 320 may then perform the biometric feature detection operation S620, the character identification operation S530, the video content identification operation S540, and the like on a newly extracted frame.

When the video content is identified, the processor 320 may output a content identifier of the video content and end a video content identification process. Even after the video content is identified, the processor 320 may proceed back to the frame extraction operation S610 and continuously perform the biometric feature detection operation S620, the character identification operation S530, and the like to update a database. In this case, the processor 320 may end the video content identification process when frame extraction on the entire video content is completed in the frame extraction operation S610. A case where frame extraction on the entire video content is completed may include a case where all the frames of the video content are extracted and a case where a certain condition indicating completion of frame extraction is satisfied, such as a case where the video content ends while sequentially extracting frames at constant time intervals. The processor 320 may end the video content identification process when frame extraction on the entire video content is completed even though the video content is not identified.

When biometric features are detected in operation S630, the processor 320 may not immediately perform the character identification operation S530 but may instead perform the frame extraction operation S610 again and then perform the character identification operation S530 only after frame extraction on the entire video content is completed. When characters are identified based on the detected biometric features in operation S640, the processor 320 may not immediately perform the video content identification operation S540 but may instead perform the frame extraction operation S610 again and then perform the video content identification operation S540 only after frame extraction on the entire video content is completed. When no characters are identified based on the detected biometric features in operation S640, the processor 320 may not immediately perform the non-identified biometric feature processing operation S650 but may instead perform the non-identified biometric feature processing operation S650 only after frame extraction on the entire video content is completed. In other words, the processor 320 may perform the character identification operation S530, the video content identification operation S540, the non-identified biometric feature processing operation S650, and the like after biometric features are collected from the entire video content.

According to an example embodiment, the processor 320 may extract a first frame from received video content and identify the video content based on the extracted first frame, and when the video content is not identified based on the first frame, extract a second frame from the video content and identify the video content based on the extracted second frame. Each of the first frame and the second frame may include a single frame or a plurality of frames. The identifying of the video content based on the second frame may include identifying the video content based on the first frame and the second frame.

According to an example embodiment, the processor 320 may extract a first frame from received video content, detect biometric features included in the extracted first frame, and identify the video content based on the detected biometric features included in the first frame. When the video content is not identified based on the biometric features included in the first frame, the processor 320 may extract a second frame from the video content, detect biometric features included in the extracted second frame, and identify the video content based on the detected biometric features included in the second frame. Any of the biometric features included in the first frame and the biometric features included in the second frame may include a single biometric feature or a plurality of biometric features. The identifying of the video content based on the biometric features included in the second frame may include identifying the video content based on the biometric features included in the first frame and the biometric features included in the second frame.

According to an example embodiment, the processor 320 may extract a first frame from received video content, detect biometric features of a first character included in the extracted first frame, identify the first character based on the detected biometric features of the first character, and identify the video content based on the identified first character When the video content is not identified based on the first character, the processor 320 may extract a second frame from the video content, detect biometric features of a second character included in the second frame, identify the second character based on the biometric features of the second character, and identify the video content based on a result of identifying the second character. Each of the first character and the second character may include a single character or a plurality of characters, and a portion or all of the first character and the second character may be common. The identifying of the second character based on the biometric features of the second character may include identifying the second character based on the biometric features of the first character and the biometric features of the second character. Identifying of the video content based on a result of identifying the second character may include identifying the video content based on a result of identifying the first character and a result of identifying the second character.

According to an example embodiment, the processor 320 may detect biometric features of characters from received video content, identify the characters based on the detected biometric features of the characters, and perform the non-identified biometric feature processing operation S650 when no characters are identified based on the detected biometric features of the characters.

The non-identified biometric feature processing operation S650 will be described with reference to FIGS. 7 through 16. As described above with reference to FIG. 6, the non-identified biometric feature processing operation S650 may be performed in the video content identification process or independently from the video content identification process to update a database. Therefore, the non-identified biometric feature processing operation S650 may also be performed for already identified video content. In this case, the processor 320 may receive a content identifier of the video content. The non-identified biometric feature processing operation S650 may be performed for at least one non-identified biometric feature detected from each frame or for non-identified biometric features detected from a plurality of frames, and as described above, the non-identified biometric feature processing operation S650 may be performed for non-identified biometric features collected after frame extraction on the entire video content is completed.

FIG. 7 is a flowchart of a non-identified biometric feature processing operation according to an example embodiment. Referring to FIG. 7, in operation S710, the processor 320 may update the content-specific non-identified biometric feature database 430 by storing, in the content-specific non-identified biometric feature database 430, a biometric feature, among at least one biometric feature detected from video content, by which a character cannot be identified. The content-specific non-identified biometric feature database 430 may be a database in which non-identified biometric features of each video content are matched with corresponding video content and stored. As described above, the biometric features stored in the database may include not only the biometric features but also any type of information indicating unique biometric features.

According to an example embodiment, the processor 320 may store non-identified biometric features of video content in the content-specific non-identified biometric feature database 430 by matching the non-identified biometric features with a content identifier of the video content. As described below, according to an example embodiment, the processor 320 may store, in the content-specific non-identified biometric feature database 430, a list of non-identified characters with respect to video content.

According to an example embodiment, the processor 320 may store non-identified biometric features of video content in the content-specific non-identified biometric feature database 430 even when the video content is not yet identified. In this case, because a content identifier of the video content is not identified, a temporary content identifier may be used. That is, the processor 320 may generate a temporary content identifier of non-identified video content and store non-identified biometric features of the video content in the content-specific non-identified biometric feature database 430 by matching the non-identified biometric features with the temporary content identifier of the video content. The temporary content identifier may be replaced by or matched with a formal content identifier when the video content is identified thereafter. The matching of the temporary content identifier with the formal content identifier may include storing, in the memory or a database, information indicating that the two content identifiers indicate the same video content. As described below, according to an example embodiment, the processor 320 may store, in the content-specific non-identified biometric feature database 430, a list of identified characters with respect to video content.

According to an example embodiment, when no characters are detected based on biometric features detected from video content and the person-specific biometric feature database 410, the processor 320 may store the detected biometric features in the content-specific non-identified biometric feature database 430 by matching the detected biometric features with a content identifier of the video content. According to an example embodiment, when no characters are detected based on biometric features detected from video content being matched with a biometric feature stored in the person-specific biometric feature database 410, the processor 320 may generate a temporary content identifier of the video content and store the detected biometric features in the content-specific non-identified biometric feature database 430 by matching the detected biometric features with the temporary content identifier of the video content.

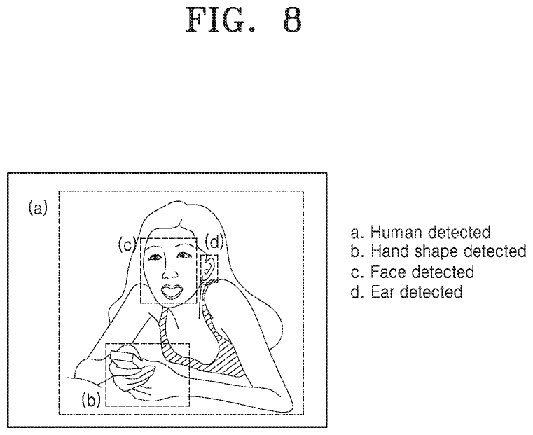

The processor 320 may store biometric features belonging to a same person in the content-specific non-identified biometric feature database 430 by matching the biometric features belonging to the same person with each other. The biometric features belonging to the same person may be the same type of biometric features or different types of biometric features. The biometric features belonging to the same person may be extracted from a same frame or different frames. Whether various biometric features belong to a same person may be determined by various methods. For example, when one human shape is recognized from an image of video content, it may be determined that a face shape, an ear shape, a hand shape, and a gait included in a corresponding human shape belong to a same person. FIG. 8 shows an example in which one human shape is recognized from an image of video content, according to an example embodiment. The processor 320 may be determined that a hand shape (b), a face shape (c), and an ear shape (d) in a recognized human shape (a) are biometric features belonging to a same person. As another example, when a voice is detected from video content, an image of the video content may be analyzed to detect a face with a mouth moving according to the voice, and accordingly, it may be determined that the voice and a corresponding face shape belong to a same person. Whether various biometric features belong to a same person may be determined through machine learning.

According to an example embodiment, the processor 320 may store biometric features, by which no characters are identified in the memory 310 or the content-specific non-identified biometric feature database 430 by matching different types of biometric features belonging to a same person with each other.

The processor 320 may use a temporary person identifier when a plurality of non-identified biometric features are matched with each other. According to an example embodiment, the processor 320 may generate temporary person identifiers for non-identified biometric features and store the non-identified biometric features in the content-specific non-identified biometric feature database 430 by matching a plurality of non-identified biometric features with a corresponding person identifier.

When one of non-identified biometric features stored in the content-specific non-identified biometric feature database 430 is matched with a non-identified biometric feature detected from the present video content, the processor 320 may use, when the non-identified biometric feature detected from the present video content is stored, a temporary person identifier matched with a corresponding non-identified biometric feature and stored in the content-specific non-identified biometric feature database 430. Alternatively, the processor 320 may match the temporary person identifier matched with the corresponding non-identified biometric feature and stored in the content-specific non-identified biometric feature database 430 with a temporary person identifier to be used when the non-identified biometric feature detected from the present video content is stored. Matching two biometric features may include determining that the two biometric features belong to a same person, and matching two temporary person identifiers may include storing, in the memory or a database, information indicating that the two temporary person identifiers indicate a same person.

According to an example embodiment, the processor 320 may detect a first type of biometric features and a second type of biometric features belonging to a same character from video content, generate a temporary person identifier of the character when the character is not identified based on the detected first type of biometric features and second type of biometric features, and store the detected first type of biometric features and second type of biometric features in the content-specific non-identified biometric feature database 430 by matching the detected first type of biometric features and second type of biometric features with the temporary person identifier of the character.

According to an example embodiment, a detected biometric feature may be stored by being matched with a frame number, a character number, a biometric feature type, and the like. For example, a biometric feature may be stored by being matched with an identifier “Frame231_Person0_HandShape”.

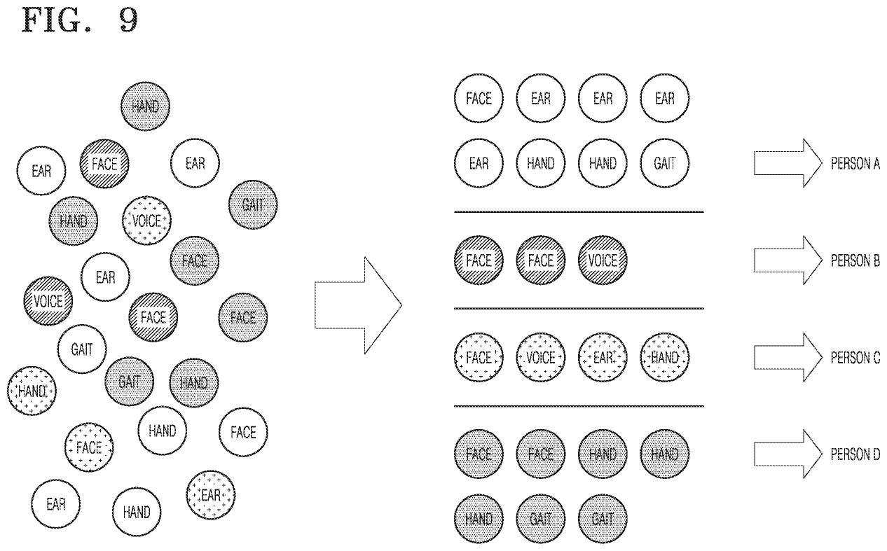

FIG. 9 shows a process of classifying biometric features of video content on a person basis, according to an example embodiment. Referring to FIG. 9, the processor 320 may classify non-identified biometric features of video content on a person basis through machine learning. The processor 320 may use t-distributed stochastic neighbor embedding (t-SNE) to classify non-identified biometric features on a person basis.

According to an example embodiment, the processor 320 may generate temporary person identifiers of classified people and store the classified person-based biometric features in the content-specific non-identified biometric feature database 430 by matching the classified person-based biometric features with temporary person identifiers of corresponding people. In this case, as described above, temporary person identifiers already stored in the content-specific non-identified biometric feature database 430 may be used. The processor 320 may match and store classified person-based biometric features with a content identifier of video content or temporary person identifiers according to whether the video content is identified. That is, the processor 320 may classify biometric features, by which no characters are identified based on the person-specific biometric feature database 410, detected from video content, on a person basis through machine learning and store the classified person-based biometric features in the content-specific non-identified biometric feature database 430 by matching the classified person-based biometric features with temporary person identifiers of corresponding people and a content identifier or temporary content identifier of the video content.

The processor 320 may classify non-identified biometric features detected from a plurality of frames on a person basis and store the classified person-based non-identified biometric features in the content-specific non-identified biometric feature database 430. The processor 320 may also classify, on a person basis, non-identified biometric features detected after frame extraction on the entire video content is completed and store the classified person-based non-identified biometric features in the content-specific non-identified biometric feature database 430.

According to an example embodiment, the processor 320 may classify non-identified biometric features on a person basis by applying machine learning to non-identified biometric features detected from the present video content and non-identified biometric features in the content-specific non-identified biometric feature database 430. According to an example embodiment, the processor 320 may classify non-identified biometric features on a person basis by applying machine learning to non-identified biometric features detected from the present video content, biometric features in the person-specific biometric feature database 410, and non-identified biometric features in the content-specific non-identified biometric feature database 430.

According to an example embodiment, the processor 320 may classify biometric features detected from video content on a person basis through machine learning and store biometric features, by which no characters are detected, among the biometric features detected in the video content in the content-specific non-identified biometric feature database 430 by matching the biometric features, by which no characters are detected, with temporary person identifiers of corresponding people.

The processor 320 may calculate a distance between biometric features and classify the biometric features on a person basis. In this case, the processor 320 may classify the biometric features on a person basis based on one type of biometric feature or by combining different types of biometric features. The processor 320 may calculate a distance for each type of biometric features, calculates one distance, i.e., a combined distance, by combining distances with respect to various biometric features, and then classify the biometric features on a person basis based on the combined distance. According to an example embodiment, the combined distance may be calculated by applying a weight to a distance of each type of biometric feature based on equation (1).

$$D ( {I}_{1} , {I}_{2} ) = {\sum }_{b = \{ face , ear , … \}}^{ } {α}_{b} {D}_{b} ( {I}_{1} , {I}_{2} ) ; {\sum }_{b = \{ face , ear , … \}}^{ } {α}_{b} = 1 \qquad ( 1 )$$

Iₖ denotes a set of biometric features belonging to a same person, b denotes a type of biometric feature, and D_{b}(Iₖ₁, Iₖ₂) denotes a distance of the type b of biometric feature between Iₖ₁ and Iₖ₂. α_{b} denotes a weight for the type b of biometric feature. The weight αb may be heuristically determined. That is, according to an example embodiment, the processor 320 may classify biometric features on a person basis by using all of different types of biometric features belonging to a same person and apply weights according to the types of the biometric features.

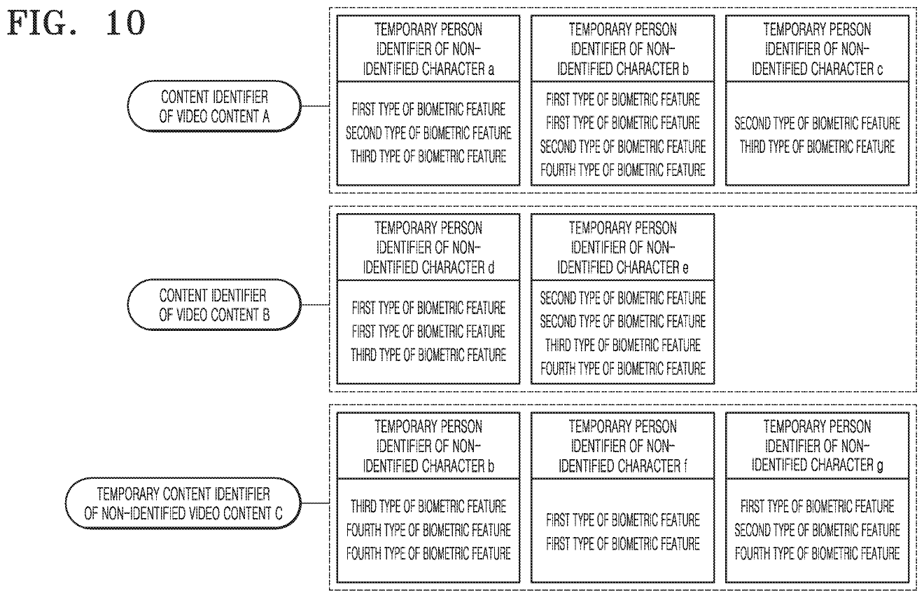

FIG. 10 shows an example of data stored in a content-specific non-identified biometric feature database, according to an example embodiment.

Referring back to FIG. 7, after performing operation S710, the processor 320 may end the non-identified biometric feature processing operation S650. As shown in FIG. 6, the processor 320 may perform the frame extraction operation S610 again after performing the non-identified biometric feature processing operation S650. Non-identified biometric features stored in the content-specific non-identified biometric feature database 430 may be compared with non-identified biometric features of other video content thereafter to identify characters corresponding to the stored non-identified biometric features. That is, the processor 320 may identify non-identified characters with respect to the content-specific non-identified biometric feature database 430 in the future.

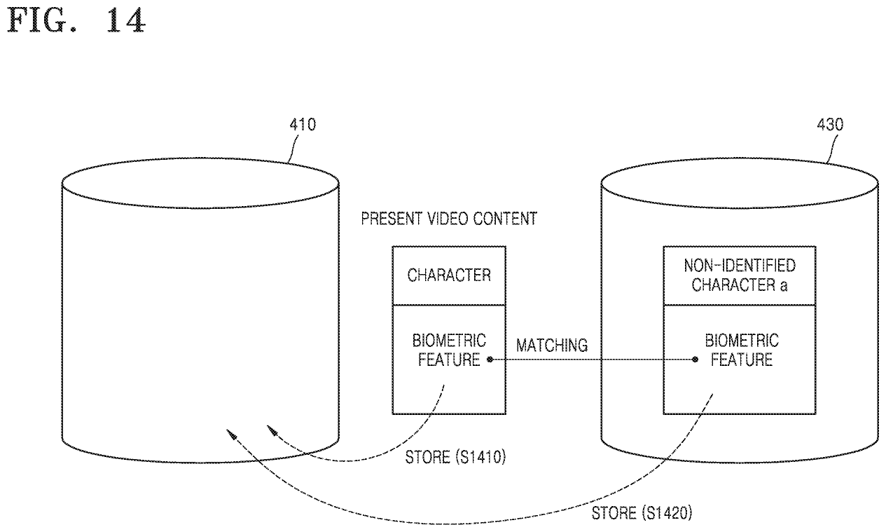

After performing operation S710, the processor 320 may proceed to operation S720 to identify non-identified characters. A non-identified character identification operation will be described below in detail. When characters corresponding to the non-identified biometric features are identified in operation S720, the processor 320 may update the person-specific biometric feature database 410 by reflecting the identified characters to the person-specific biometric feature database 410 in operation S730. That is, when characters are identified based on the content-specific non-identified biometric feature database 430, the processor 320 may store biometric features, by which the characters have been identified, in the person-specific biometric feature database 410 by matching the biometric features with person identifiers of the characters. As described above, the biometric features stored in the database may include not only the biometric features but also any type of information indicating unique biometric features. A method of reflecting biometric features, by which characters have been identified, in the person-specific biometric feature database 410 will be described below again with reference to FIGS. 14 to 16. The processor 320 may delete information about the identified characters from the content-specific non-identified biometric feature database 430.

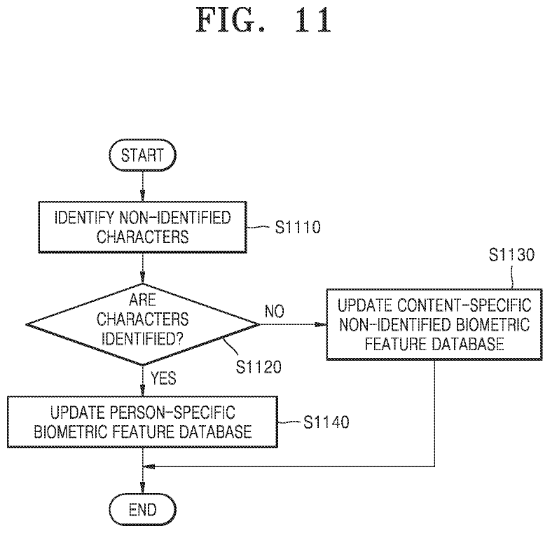

FIG. 11 is a flowchart of a non-identified biometric feature processing operation according to another example embodiment. In a description of FIG. 11, the description made in relation to FIG. 7 may be omitted to prevent redundancy. Referring to FIG. 11, in operation S1110, the processor 320 may perform a non-identified character identification operation on non-identified biometric features detected from video content. That is, the processor 320 may identify characters based on the detected biometric features being matched with a biometric feature stored in the content-specific non-identified biometric feature database 430 when no characters are identified based on the detected biometric features being matched with a biometric feature stored in the person-specific biometric feature database 410. The non-identified character identification operation will be described below in detail.

When characters corresponding to the non-identified biometric features are determined as not being identified in operation S1120, the processor 320 may proceed to operation S1130 to store the non-identified biometric features in the content-specific non-identified biometric feature database 430. When characters corresponding to the non-identified biometric features are determined as being identified in operation S1120, the processor 320 may proceed to operation S1140 to reflect the identified characters to the person-specific biometric feature database 410. That is, when characters are identified based on biometric features detected from the present video content being matched with a biometric feature stored in the content-specific non-identified biometric feature database 430, the processor 320 may store the detected biometric features in the person-specific biometric feature database 410 by matching the detected biometric features with person identifiers of the characters. The processor 320 may then delete information about the identified characters from the content-specific non-identified biometric feature database 430.

The non-identified character identification operation will now be described in detail. The processor 320 may identify characters based on the content-specific non-identified biometric feature database 430 with respect to biometric features, when no characters are identified based on the person-specific biometric feature database 410 among biometric features detected from video content. That is, the processor 320 may identify characters corresponding to non-identified biometric features by comparing non-identified biometric features of the present video content with the content-specific non-identified biometric feature database 430. In this case, the non-identified biometric features of the present video content may be included in the content-specific non-identified biometric feature database 430 (as discussed the example embodiment of FIG. 7) or not be included therein (as discussed in the example embodiment of FIG. 11).

The processor 320 may identify characters by using machine learning. According to an example embodiment, the processor 320 may identify characters by classifying detected biometric features on a per person basis by using machine learning and then comparing the classified person-based biometric features with the content-specific non-identified biometric feature database 430. According to an example embodiment, the processor 320 may identify characters by applying machine learning to non-identified biometric features of the present video content and the content-specific non-identified biometric feature database 430. According to an example embodiment, the processor 320 may identify characters by applying machine learning to non-identified biometric features of the present video content, biometric features in the person-specific biometric feature database 410, and non-identified biometric features in the content-specific non-identified biometric feature database 430. The processor 320 may enhance data in the person-specific biometric feature database 410 or correct an error of the data according to a non-identified character identification result.

The processor 320 may perform the non-identified character identification operation on only identified video content or also perform the non-identified character identification operation on non-identified video content.

### First Example Embodiment

The first example embodiment performs a non-identified character identification operation on identified video content. In this case, only information about identified video content is stored in the content-specific non-identified biometric feature database 430, or only information about identified video content, among information stored in the content-specific non-identified biometric feature database 430, may be used.

When certain video content is identified, a character list of the video content may be obtained from the content-specific character database 420. When characters having biometric feature data that is stored in the person-specific biometric feature database 410 are excluded from the obtained character list, a list of characters having biometric feature data that is not stored in the person-specific biometric feature database 410 may be obtained. Hereinafter, a list of characters, of which biometric feature data is not stored in the person-specific biometric feature database 410 is referred to as a ‘non-identified character list’. The processor 320 may store a non-identified character list for each video content in the content-specific non-identified biometric feature database 430.

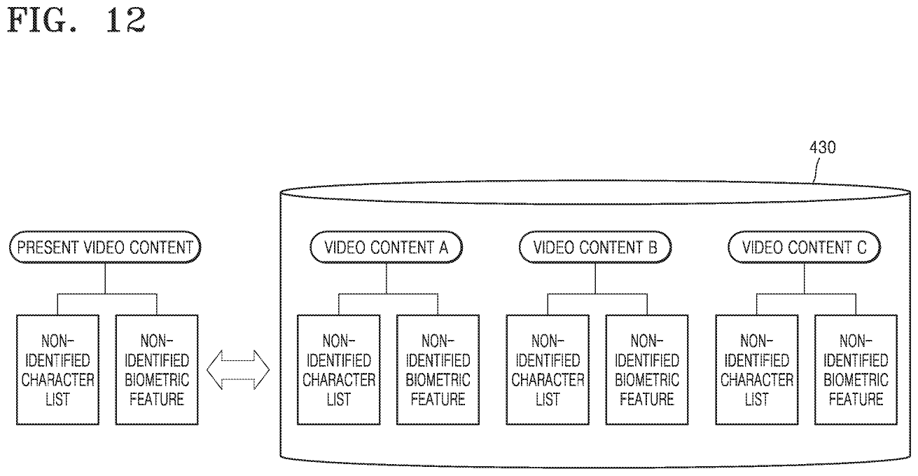

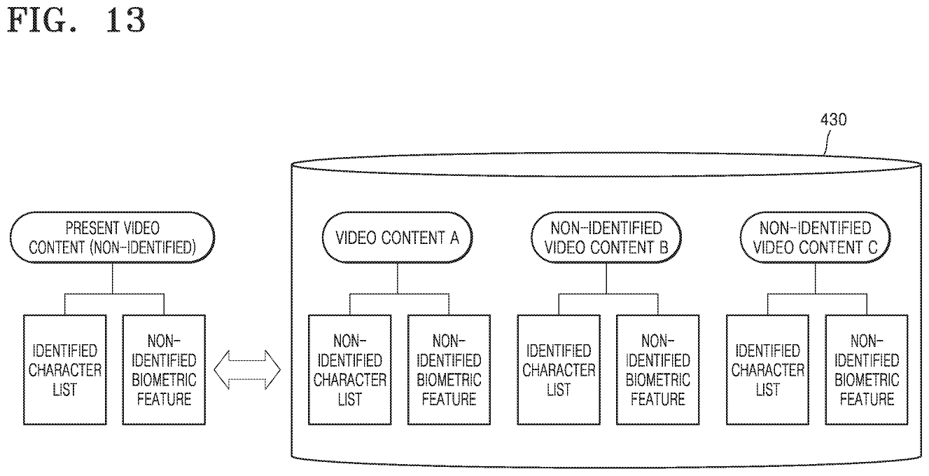

FIG. 12 shows a non-identified character identification operation according to the first example embodiment. In FIG. 12, data about the present video content may be included in the content-specific non-identified biometric feature database 430 or may not be included therein. For convenience, the data is shown separately from the content-specific non-identified biometric feature database 430 according to the meaning indicating that the present video content is video content to be currently analyzed. This also applied to FIGS. 13 through 16, 18, and 19 to be described below. As described above, content-specific non-identified biometric features may be classified on a person basis and stored.

Referring to FIG. 12, the processor 320 may identify a character corresponding to a non-identified biometric feature of the present video content based on a non-identified character list and non-identified biometric features of the present video content, as well as a non-identified character list and non-identified biometric features of video content in the content-specific non-identified biometric feature database 430. The processor 320 may identify a character corresponding to a non-identified biometric feature of the present video content by determining common non-identified characters and matching non-identified biometric features between the present video content and other pieces of video content in the content-specific non-identified biometric feature database 430. In this case, as described above, the processor 320 may identify a character by using machine learning. As an example, when the number of non-identified characters common to two pieces of video content is 1 and there exists a non-identified biometric feature common to the two pieces of video content, it may be determined that the non-identified biometric feature belongs to the common character. This determination may be persistently corrected or complemented through a database update process in the future.

The processor 320 may reduce a computation amount by using, as comparative targets, only pieces of video content having non-identified character lists common to the non-identified character list of the present video content among the other pieces of video content stored in the content-specific non-identified biometric feature database 430. In some example embodiments, the processor 320 may use a total list of characters instead of using the non-identified character list.

The non-identified character identification operation may be performed for each type of biometric features. That is, a non-identified character list may be stored for each type of biometric features, and the processor 320 may identify a character corresponding to a non-identified biometric feature of the present video content based on comparing a certain type of non-identified character list and non-identified biometric features of the present video content with a corresponding type of non-identified character list and non-identified biometric features of video content in the content-specific non-identified biometric feature database 430. For example, when a hand shape is detected from the present video content, a character may be identified based on the detected hand shape, a non-identified character list related to a hand shape in the present video content, and non-identified hand shapes and non-identified character lists related to a hand shape in other pieces of video content in the content-specific non-identified biometric feature database 430.

### Second Example Embodiment

The second example embodiment relates to a non-identified character identification operation performed by also including non-identified video content. In this case, information about identified video content and non-identified video content may be stored in the content-specific non-identified biometric feature database 430. The description made in relation to the first example embodiment may be omitted to prevent redundancy.

As described above, non-identified biometric features of each non-identified video content may be matched with temporary content identifiers and stored. The processor may store an identified character list for each piece of non-identified video content. Hereinafter, a list of characters identified based on biometric features detected from certain video content is referred to as an ‘identified character list’ of the certain video content. The identified characters may be identified based on the person-specific biometric feature database 410 or the content-specific non-identified biometric feature database 430.

For example, a content identifier, a non-identified character list, and non-identified biometric features are matched with identified video content and stored in the memory or the content-specific non-identified biometric feature database 430. A temporary content identifier, an identified character list, and non-identified biometric features are matched with non-identified video content and stored in the memory or the content-specific non-identified biometric feature database 430.

FIG. 13 shows a non-identified character identification operation according to the second example embodiment. The present video content may be identified or may not be identified, and FIG. 13 shows a case where the present video content is not identified. The processor 320 may identify a character corresponding to a non-identified biometric feature of video content by comparing information about the non-identified biometric feature of the video content with the content-specific character database 420 and the content-specific non-identified biometric feature database 430. In this case, the processor 320 may use a non-identified character list and non-identified biometric features for identified video content and use an identified character list and non-identified biometric features for non-identified video content. That is, the processor 320 may identify a character corresponding to a non-identified biometric feature of the present video content based on the content-specific character database 420, a non-identified character list and non-identified biometric features of each identified video content among the present video content and video contents in the content-specific non-identified biometric feature database 430, and an identified character list and non-identified biometric features of each non-identified video content among the present video content and video contents in the content-specific non-identified biometric feature database 430. The processor 320 may use a total list of characters instead of using the non-identified character list.

In this process, non-identified video content may be identified. That is, the processor 320 may identify video content based on the content-specific character database 420, a non-identified character list and non-identified biometric features of each identified video content among the present video content and video contents in the content-specific non-identified biometric feature database 430, and an identified character list and non-identified biometric features of each non-identified video content among the present video content and video contents in the content-specific non-identified biometric feature database 430. Both a non-identified character and non-identified video content may be identified, only the non-identified video content may be identified without identifying the non-identified character, or only the non-identified character may be identified without identifying the non-identified video content.

Different temporary content identifiers stored in the content-specific non-identified biometric feature database 430 may be determined as indicating same video content, or different temporary person identifiers may be determined as indicating a same character.

As described in the first example embodiment, the process described above may be performed for each type of biometric feature. However, an identified character list may include a character identified based on another type of biometric feature.

An operation of updating the person-specific biometric feature database 410 is described below. The person-specific biometric feature database update operation may be performed in a video content identification operation or independently from the video content identification operation. FIG. 14 shows an operation of updating the person-specific biometric feature database 410, according to an example embodiment. Referring to FIG. 14, when a character is identified based on a biometric feature detected from the present video content and the content-specific non-identified biometric feature database 430, in operation S1410, the processor 320 may match the biometric feature detected from the present video content with a person identifier of the identified character and store the matched biometric feature in the person-specific biometric feature database 410. In operation S1420, the processor 320 may match a non-identified biometric feature in the content-specific non-identified biometric feature database 430, which is matched with the biometric feature detected from the present video content, with the person identifier of the identified character and store the matched non-identified biometric feature in the person-specific biometric feature database 410. As described above, matching two biometric features includes determining that the two biometric features belong to a same person. The processor 320 may delete information about the identified character from the content-specific non-identified biometric feature database 430.

The process described above may be performed for each type of biometric feature. Therefore, for the identified character, a different type of biometric feature from the biometric feature used for the character identification may be already stored in the person-specific biometric feature database 410.

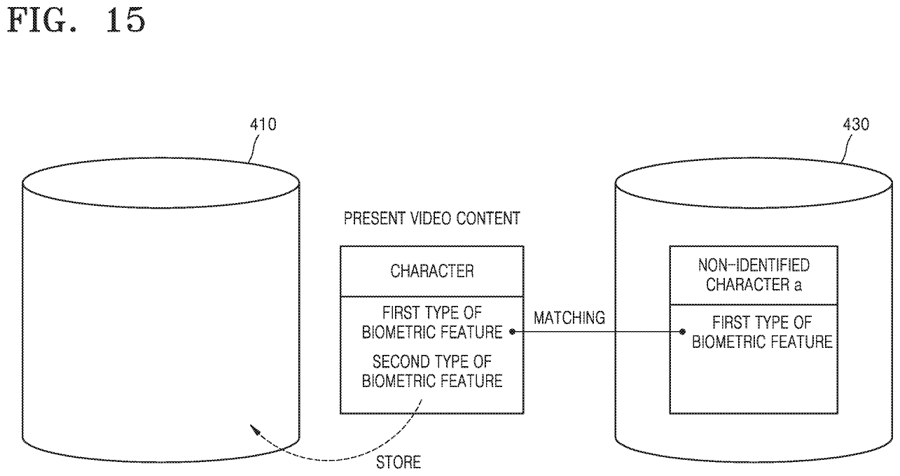

Alternatively, for the identified character, a different type of biometric feature from the biometric feature used for the character identification may be added to the person-specific biometric feature database 410. FIG. 15 shows an operation of updating the person-specific biometric feature database 410, according to an example embodiment. Referring to FIG. 15, the processor 320 may detect a first type of biometric feature and a second type of biometric feature of a same character from the present video content, identify the character based on the detected first type of biometric feature and a match in the content-specific non-identified biometric feature database 430, and store the second type of biometric feature of the character in the person-specific biometric feature database 410 by matching the second type of biometric feature with a person identifier of the character. For the identified character, a third type of biometric feature may be already stored in the person-specific biometric feature database 410.

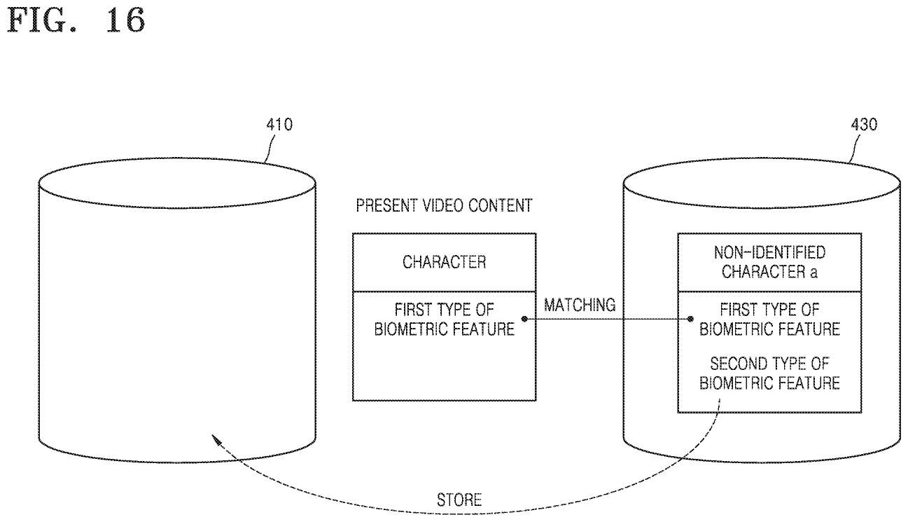

FIG. 16 shows an operation of updating the person-specific biometric feature database 410, according to an example embodiment. Referring to FIG. 16, the processor 320 may detect a first type of biometric feature of a character from the present video content; identify the character based on the detected first type of biometric feature and a match in the content-specific non-identified biometric feature database 430; match a second type of biometric feature in the content-specific non-identified biometric feature database 430, which is matched with the detected first type of biometric feature, with a person identifier of the character; and store the matched second type of biometric feature in the person-specific biometric feature database 410. The second type of biometric feature, which is matched with the detected first type of biometric feature, may be determined to belong to the same person that the detected first type of biometric feature belongs. The second type of biometric feature, which is matched with the detected first type of biometric feature, may be stored in the content-specific non-identified biometric feature database 430 by being matched with the same temporary person identifier as a first type of biometric feature in the content-specific non-identified biometric feature database 430, which is matched with the detected first type of biometric feature. For the identified character, a third type of biometric feature may be already stored in the person-specific biometric feature database 410. The processor 320 may delete information about the identified character from the content-specific non-identified biometric feature database 430.

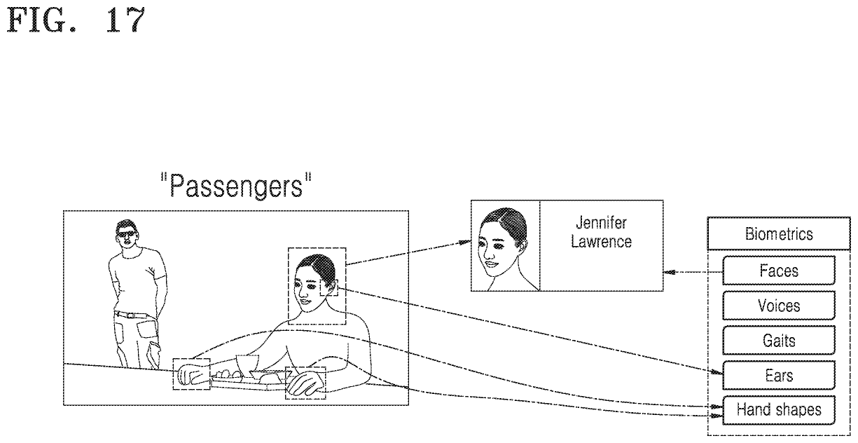

Biometric feature information may be updated for the successfully identified character based on the person-specific biometric feature database 410. For example, when only face shape information exists without other biometric feature information for a certain actor in the person-specific biometric feature database 410, and face shapes of the actor are detected from video content, the face shape information may be enhanced by reflecting the detected face shapes to the person-specific biometric feature database 410. When other biometric feature information (e.g., a hand shape, an ear shape, a voice, and a gait) of the actor is detected, the detected other biometric feature information may be added to the person-specific biometric feature database 410. FIG. 17 shows a process of adding, to a person-specific biometric feature database, hand shape and ear shape data of an actor whose a face has been identified, according to an example embodiment.

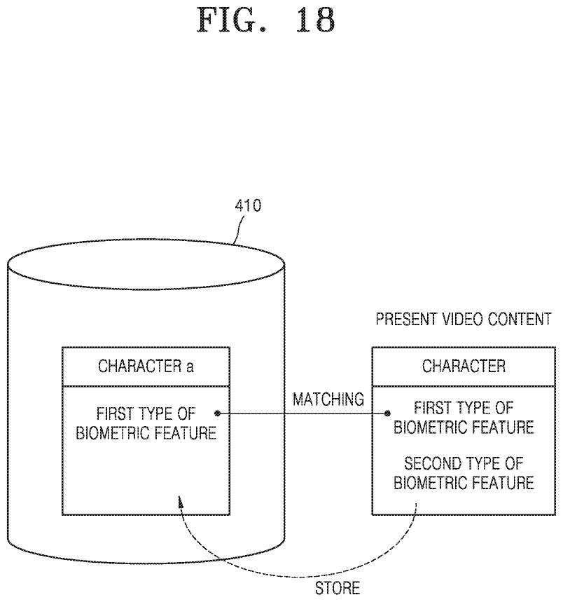

FIG. 18 shows an operation of updating the person-specific biometric feature database 410, according to an example embodiment. Referring to FIG. 18, the processor 320 may detect a first type of biometric feature and a second type of biometric feature of a same character from the present video content, identify the character based on the detected first type of biometric feature and a match in the person-specific biometric feature database 410, match the detected second type of biometric feature with a person identifier of the identified character, and store the matched second type of biometric feature in the person-specific biometric feature database 410. The processor 320 may enhance a first type of biometric feature information of the character by matching the detected first type of biometric feature with the person identifier of the identified character and storing the matched first type of biometric feature in the person-specific biometric feature database 410.

Alternatively, when the character cannot be identified based on the second type of biometric feature and a match in the person-specific biometric feature database 410, the second type of biometric feature may be matched with another non-identified biometric feature stored in the content-specific non-identified biometric feature database 430. In this case, the person-specific biometric feature database 410 may be updated based on the matched non-identified biometric feature. The matched non-identified biometric feature may be a different type from the second type of biometric feature. For example, when a face shape and a hand shape of an actor are detected from video content, the actor is identified based on the detected face shape and the person-specific biometric feature database 410, and hand shape data corresponding to the detected hand shape is discovered from the content-specific non-identified biometric feature database 430, the hand shape data in the content-specific non-identified biometric feature database 430 may be matched with a person identifier of the actor identified based on the detected face shape and stored in the person-specific biometric feature database 410. Furthermore, when voice data matched with the same temporary person identifier as the hand shape data is included in the content-specific non-identified biometric feature database 430, the voice data may be matched with the person identifier of the identified actor and stored in the person-specific biometric feature database 410.

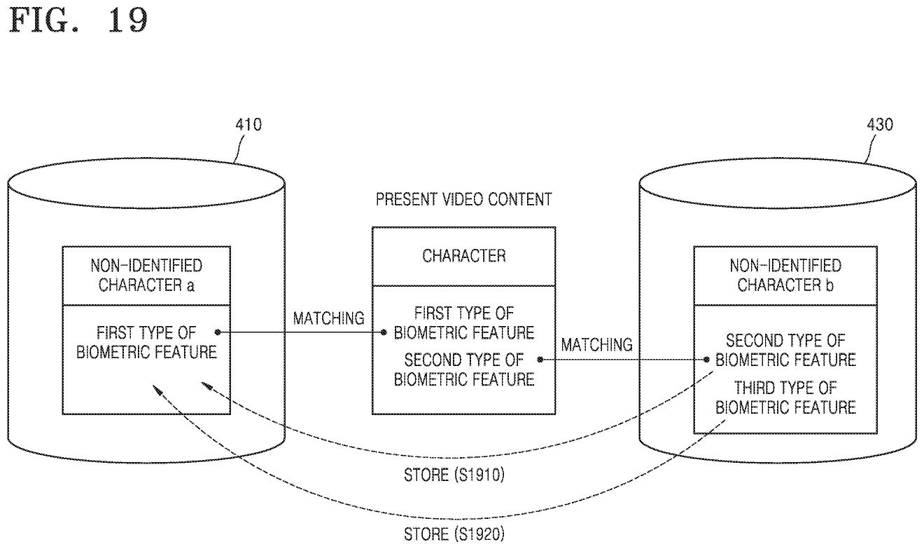

FIG. 19 shows an operation of updating the person-specific biometric feature database 410, according to an example embodiment. Referring to FIG. 19, the processor 320 may detect a first type of biometric feature and a second type of biometric feature of a same character from the present video content and identify the character based on the detected first type of biometric feature and a match in the person-specific biometric feature database 410. In operation S1910, the processor 320 may match a second type of biometric feature in the content-specific non-identified biometric feature database 430, which is matched with the detected second type of biometric feature, with a person identifier of the character and store the matched second type of biometric feature in the person-specific biometric feature database 410. In operation S1920, the processor 320 may match a third type of biometric feature in the content-specific non-identified biometric feature database 430, which is matched with the detected second type of biometric feature, with the person identifier of the character and store the matched third type of biometric feature in the person-specific biometric feature database 410. The third type of biometric feature, which is matched with the detected second type of biometric feature, is determined to belong to the same person as the detected second type of biometric feature belongs. The third type of biometric feature, which is matched with the detected second type of biometric feature, may be stored in the content-specific non-identified biometric feature database 430 by being matched with the same temporary person identifier as a second type of biometric feature in the content-specific non-identified biometric feature database 430, which is matched with the detected second type of biometric feature. The processor 320 may delete related data from the content-specific non-identified biometric feature database 430.

The operations of updating the person-specific biometric feature database 410 based on biometric features of a character, which have been described with reference to FIGS. 14 to 19, may be persistently performed for secured pieces of video content, thereby making the person-specific biometric feature database 410 gradually better. As described above, a process of updating the person-specific biometric feature database 410 may be separately performed irrelevant to a video content identification process. Therefore, an operation of updating the person-specific biometric feature database 410 may be performed by a separate device for performing only a database update operation without performing a video content identification process.

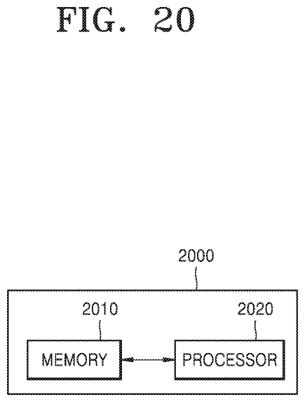

FIG. 20 is a block diagram of an apparatus 2000 for updating a biometric feature database, according to an example embodiment. Referring to FIG. 20, the apparatus 2000 using biometric features of characters may include a memory 2010 storing one or more instructions and a processor 2020 configured to execute the one or more instructions stored in the memory 2010. The memory 2010 may include a single memory or a plurality of memories. The processor 2020 may include a single processor or a plurality of processors. The processor 2020 may receive video content, detect biometric features of characters from the received video content, identify the character based on the detected biometric features, and update the person-specific biometric feature database 410 based on the detected biometric features and a result of identifying the characters. The processor 2020 may receive a content identifier of video content and update the person-specific biometric feature database 410 based on the received content identifier. The processor 2020 may update the person-specific biometric feature database 410 based on the content-specific character database 420. The processor 2020 may update the person-specific biometric feature database 410 based on the content-specific non-identified biometric feature database 430. The processor 2020 may perform any operation except for a video content identification operation among the operations described above with reference to FIGS. 1 through 18. The biometric feature database update apparatus 2000 may be included in the apparatus 300.

The processor 320 or 2020 of the apparatus 300 or the biometric feature database update apparatus 2000 may update the content-specific character database 420. For example, when an unknown actor who is not listed in a cast list of a certain movie becomes famous in the future, and a biometric feature of the actor is detected by analyzing the movie, the actor may be added to the cast list of the movie.

According to an example embodiment, the processor 320 or 2020 may detect a biometric feature of a character from video content and update the content-specific character database 420 based on at least one of the detected biometric feature, the person-specific biometric feature database 410, or a content identifier of the video content. The processor 320 or 2020 may update the person-specific biometric feature database 410 based on the content-specific non-identified biometric feature database 430.

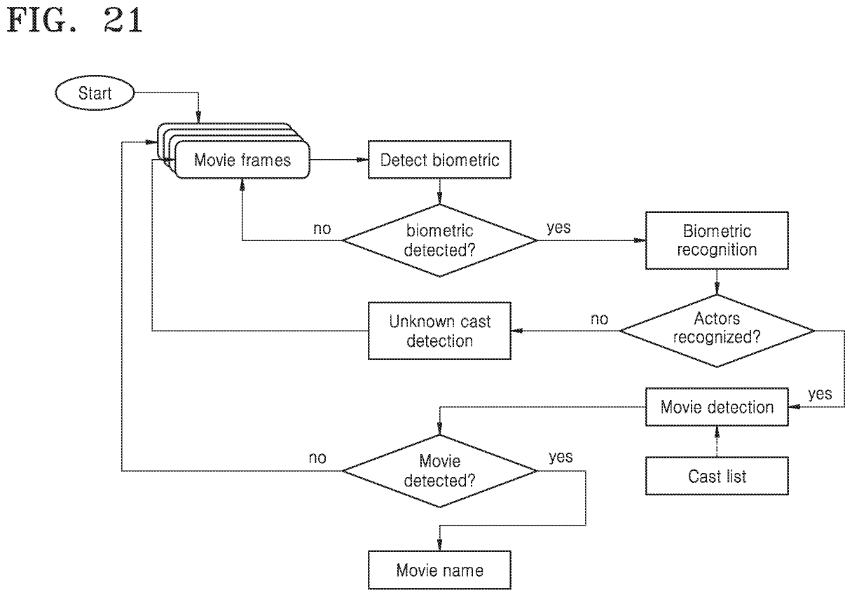

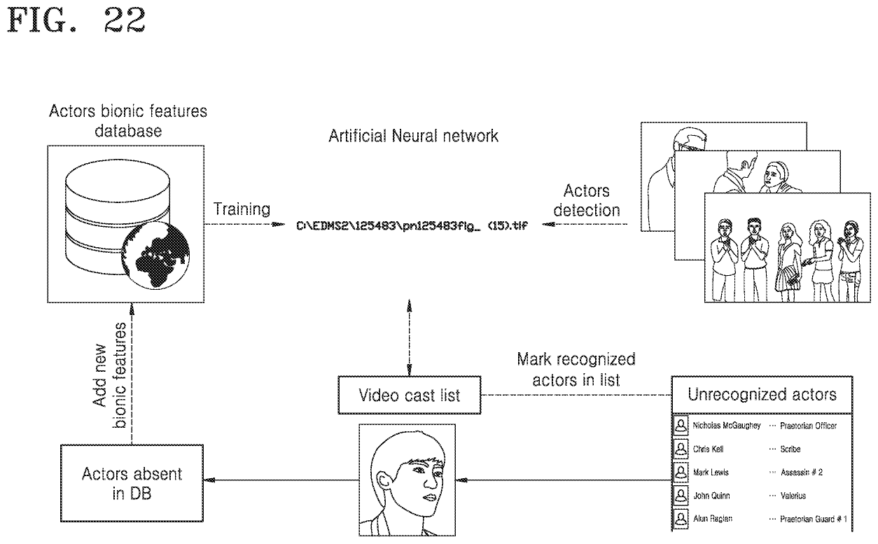

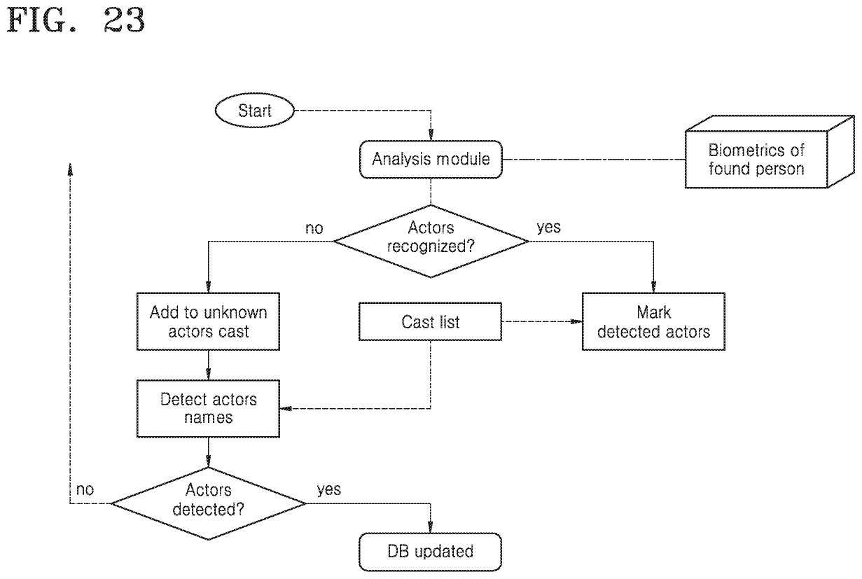

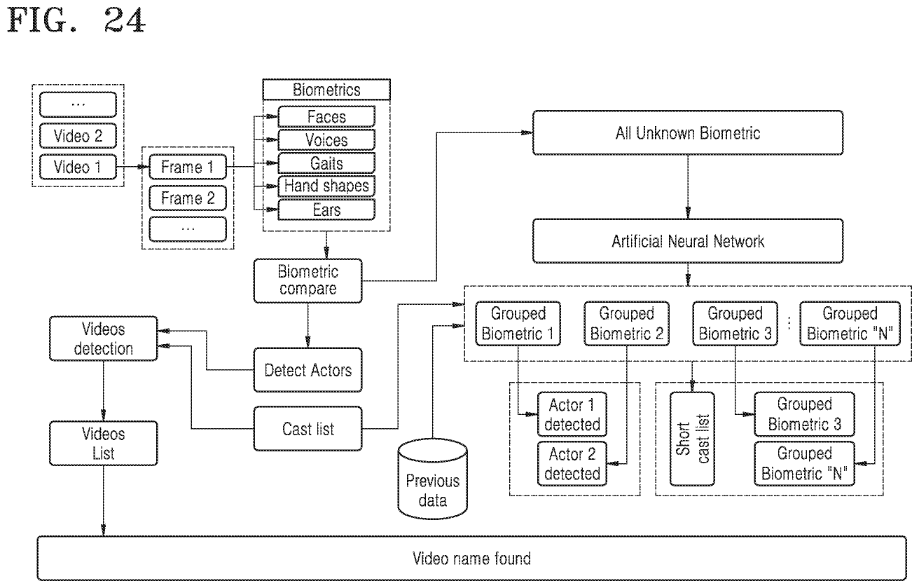

FIG. 21 is a flowchart of a method of identifying video content based on biometric features of characters, according to an example embodiment. FIG. 22 is a flowchart of a method of identifying a non-identified character and updating a database, according to an example embodiment. FIG. 23 is a flowchart of a method of identifying a non-identified character and updating a database, according to an example embodiment. FIG. 24 is a flowchart of a method of identifying video content based on biometric features of characters, according to an example embodiment.

An embodiment of the disclosure may be implemented in a form of a recording medium including computer-executable instructions such as a program module executed by a computer system. A non-transitory computer-readable medium may be an arbitrary available medium which may be accessed by a computer system and includes all types of volatile and nonvolatile media and separated and non-separated media. In addition, the non-transitory computer-readable medium may include all types of computer storage media and communication media. The computer storage media include all types of volatile and nonvolatile and separated and non-separated media implemented by an arbitrary method or technique for storing information such as computer-readable instructions, a data structure, a program module, or other data. The communication media typically include computer-readable instructions, a data structure, a program module, and other data of a modulated signal. In addition, a database used in the disclosure may be recorded on a recording medium.

The disclosure has been described in detail with the exemplary embodiments shown in the drawings. The embodiments of the disclosure are only illustrative without limiting the disclosure and should be understood in the illustrative sense only and not for the purpose of limitation in all aspects. It will be understood by those of ordinary skill in the art to which the disclosure belongs that various changes in form and details may be made in the embodiments of the disclosure without changing the technical scope and mandatory features of the disclosure. For example, each component described as a single type may be carried out by being distributed, and likewise, components described as a distributed type may also be carried out by being coupled.

Although specific terms are used in the specification, the terms are for the purpose of describing the disclosure only and are not intended to be limiting of the meaning or the scope of the disclosure as defined by the claims. Each operation of the disclosure does not have to be necessarily performed according to the described sequence and may be performed in parallel, selectively, or individually.

The true technical scope of the disclosure should be defined not by the above description but by the technical idea of the appended claims, and the meaning and scope of the claims and all changed or modified forms derived from the equivalent concept thereof are included in the scope of the disclosure. It should be understood that the equivalents include not only currently known equivalents but also equivalents to be developed in the future, i.e., all components disclosed to perform the same function irrelevant to a structure.

What is claimed is:

1. An apparatus for identifying video content, the apparatus comprising:
a memory storing one or more instructions; and
at least one processor configured to execute the one or more instructions to:
receive video content;
detect biometric features of characters in the video content;
identify the characters based on the detected biometric features;
identify the video content based on the identity of the characters; and
output a content identifier of the video content based on the identity of the video content.

2. The apparatus of claim 1, wherein the at least one processor is further configured to execute the one or more instructions to:
extract a first frame from the video content;
detect biometric features included in the first frame;
identify the video content based on the biometric features included in the first frame; and
when the video content is not identifiable based on the biometric features included in the first frame, extract a second frame from the video content, detect biometric features included in the second frame, and identify the video content based on the detected biometric features included in the second frame.

3. The apparatus of claim 1, wherein the at least one processor is further configured to execute the one or more instructions to:
identify the characters based on the detected biometric features being matched with a person-specific biometric feature stored in a person-specific biometric feature database; and
identify the video content based on the identified characters being matched with a character list stored in a content-specific character database.

4. The apparatus of claim 1, wherein the at least one processor is further configured to execute the one or more instructions to store a biometric feature detected in the video content, by which a character has not been identified, in a content-specific non-identified biometric feature database by matching the biometric feature with the content identifier of the video content.

5. The apparatus of claim 1, wherein the at least one processor is further configured to execute the one or more instructions to:
generate a temporary content identifier of the video content; and
store a biometric feature detected in the video content, by which a character has not been identified, in a content-specific non-identified biometric feature database by matching the biometric feature with the temporary content identifier of the video content.

6. The apparatus of claim 1, wherein the at least one processor is further configured to execute the one or more instructions to store biometric features detected in the video content, by which no characters have been identified, in a content-specific non-identified biometric feature database by matching different types of biometric features corresponding to a same person with each other.

7. The apparatus of claim 1, wherein the at least one processor is further configured to execute the one or more instructions to:
classify biometric features detected in the video content, by which no characters have been identified, on a per person basis through machine learning; and
store the classified person-based biometric features in a content-specific non-identified biometric feature database by matching the classified person-based biometric features with a temporary person identifier of a person having a matching biometric feature.

8. The apparatus of claim 7, wherein the at least one processor is further configured to execute the one or more instructions to:
classify the biometric features on a per person basis based on different types of biometric features corresponding to a same person; and
apply weights corresponding to the types of the biometric features.

9. The apparatus of claim 1, wherein the at least one processor is further configured to execute the one or more instructions to identify a character corresponding to a biometric feature that has not been identified through a person-specific biometric feature database, based on a matching biometric feature in a content-specific non-identified biometric feature database.

10. The apparatus of claim 1, wherein the at least one processor is further configured to execute the one or more instructions to identify a character corresponding to a non-identified biometric feature of the received video content based on comparing a non-identified character list and non-identified biometric features of the received video content with a non-identified character list and non-identified biometric features of a video content in a content-specific non-identified biometric feature database.

11. The apparatus of claim 1, wherein the at least one processor is further configured to execute the one or more instructions to identify a character corresponding to a non-identified biometric feature of the received video content based on comparing a content-specific character database with:
a non-identified character list and non-identified biometric features of each identified video content among the received video content and video contents in a content-specific non-identified biometric feature database; and
an identified character list and non-identified biometric features of each non-identified video content among the received video content and video contents in the content-specific non-identified biometric feature database.

12. The apparatus of claim 1, wherein the at least one processor is further configured to execute the one or more instructions to identify the received video content based on comparing a content-specific character database with:
a non-identified character list and non-identified biometric features of each identified video content among the received video content and video contents in a content-specific non-identified biometric feature database; and
an identified character list and non-identified biometric features of each non-identified video content among the received video content and video contents in the content-specific non-identified biometric feature database.

13. The apparatus of claim 1, wherein the at least one processor is further configured to execute the one or more instructions to:
identify the characters based on the detected biometric features being matched with biometric features stored in a content-specific non-identified biometric feature database; and
store the detected biometric features in a person-specific biometric feature database by matching the detected biometric features with person identifiers of the characters.

14. The apparatus of claim 1, wherein the at least one processor is further configured to execute the one or more instructions to:
detect a first type of biometric feature of a character in the video content;
identify the character based on the detected first type of biometric feature being matched with a biometric feature stored in a content-specific non-identified biometric feature database; and
store a second type of biometric feature, that is matched with the detected first type of biometric feature and stored in the content-specific non-identified biometric feature database, in a person-specific biometric feature database by matching the second type of biometric feature with a person identifier of the character.

15. The apparatus of claim 1, wherein the at least one processor is further configured to execute the one or more instructions to:
detect a first type of biometric feature and a second type of biometric feature of a character in the video content;
identify the character based on the detected first type of biometric feature being matched with a biometric feature stored in a person-specific biometric feature database; and
store the detected second type of biometric feature in the person-specific biometric feature database by matching the detected second type of biometric feature with a person identifier of the character.

16. The apparatus of claim 1, wherein the at least one processor is further configured to execute the one or more instructions to:
detect a first type of biometric feature and a second type of biometric feature of a character in the video content;
identify the character based on the detected first type of biometric feature being matched with a biometric feature stored in a person-specific biometric feature database; and
store a third type of biometric feature, that is matched with the detected second type of biometric feature and stored in a content-specific non-identified biometric feature database, in the person-specific biometric feature database by matching the third type of biometric feature with a person identifier of the character.

17. The apparatus of claim 3, wherein the at least one processor is further configured to execute the one or more instructions to update the content-specific character database based on at least one of the detected biometric features, the person-specific biometric feature database, or the content identifier of the video content.

18. An apparatus for updating a biometric feature database, the apparatus comprising: a memory storing one or more instructions; and
at least one processor configured to execute the one or more instructions to:
receive video content;
detect biometric features of characters in the video content;
identify the characters based on the detected biometric features; and
update the biometric feature database based on the detected biometric features and a result of identifying the characters.

19. A method of identifying video content, the method comprising:
receiving video content;
detecting biometric features of characters in the video content;
identifying the characters based on the detected biometric features;
identifying the video content based on a result of identifying the characters; and
outputting a content identifier of the video content based on a result of identifying the video content.

20. A non-transitory computer-readable recording medium having recorded thereon a program for executing the method of claim 19.
